(19) United States
(12) Patent Application Publication
(10) Pub. No.: US 2010/0071627 A1
(43) Pub. Date: Mar. 25, 2010

(54) Bed System for a pet

(76) Inventor: Dennis Beard, Holland, MI (US)

Correspondence Address: THE WATSON INTELLECTUAL PROPERTY GROUP, PLC, 3133 HIGHLAND DRIVE, SUITE 200, HUDSONVILLE, MI, 49426, US

(21) Appl. No.: 12/284,459

(22) Filed: Sep. 22, 2008

(51) Int. Cl. A01K 29/00; A01K 1/10

(52) U.S. Cl. 119/28.5; 119/61.5

(57) ABSTRACT

A bed system for a pet comprising a bed assembly having an outside shell and an inside surface opposing the outside shell. The inside surface comprises an outwardly concave configuration that includes a depth, the bed assembly being filled with a plural of fiber bundles that are heated so as to melt into a integrally formed article.

### BACKGROUND OF THE DISCLOSURE

1. Field of the Disclosure

The disclosure relates in general to pet bedding, and more particularly, to a bed system for a pet which provides an improved surface and configuration for the pet to retain a natural sleep position.

2. Background Art

Bedding for animals, and in particular, domesticated pets that live within the home are well known. These beds typically include a cushion that may or may not be covered with a fabric. Typically, these cushions are substantially flat and may include walls that extend along the perimeter of the cushion. While this is an improvement for the pet over a rug or a towel, there are nevertheless drawbacks.

Among other drawbacks, one drawback is that pet beds are generally substantially flat and often less than optimal for the pet. For example, often a urethane foam member is utilized. Generally the foam member comprises a cut piece of foam that has a flat top. The flat top is generally not conducive for the pet and the pet generally lies in a less than optimal position.

It is an object of the present invention to provide a pet bed that is easily formed into a configuration that is comfortable to a pet.

It is another object of the present invention to provide for a pet bed that can be easily formed.

These objects as well as other objects of the present invention will become apparent in light of the present specification, claims, and drawings.

### SUMMARY OF THE DISCLOSURE

The disclosure is directed to a bed system for a pet comprising a bed assembly having an outside shell and an inside surface opposing the outside shell. The inside surface comprises an outwardly concave configuration that includes a depth, the bed assembly being filled with a plural of fiber bundles that are heated so as to melt into a integrally formed article.

In a preferred embodiment, the inside surface comprises a substantially hemispherically shaped configuration defined by a major diameter, a minor diameter and a depth collectively defining a cavity.

In another embodiment, the major diameter is between 2.5 and 6 times the depth, and wherein the minor diameter is between 0.5 and 1 times the major diameter.

Preferably, a fabric is bonded to each of the outside shell and inside surface.

In a preferred embodiment, the major diameter and the minor diameter are substantially identical.

In a preferred embodiment, the system further comprises an outer rim transitioning from the outside shell to the inside surface.

In one such embodiment, the outer rim comprises a semicircular configuration.

In one configuration, the system further comprises at least one accessory coupled to the outer rim of the bed assembly.

Preferably, the at least one accessory is selected from the group consisting of dishes, chew toys and storage bins.

In another embodiment, the fiber bundles comprise a plurality of different types of fiber bundles which are positioned in predetermined locations so as to provide a predetermined localized density and fiber bundle type.

In one such embodiment, the system further comprises a base having a surface engagement member and a bed assembly coupling. The surface engagement member is structurally configured to engage an outside surface. The bed assembly coupling configured to engage the outside shell of the bed assembly to provide structure thereto.

In another embodiment, the inside surface further includes an inside surface configuration comprising a plurality of convex surface structures positioned thereon and emanating therefrom.

In another aspect of the invention, the invention comprises a bed system for a pet comprising a bed assembly having an outside shell and an inside surface opposing to the outside shell. The inside surface comprises an outwardly concave configuration that includes a depth. The outwardly concave configuration has a substantially hemispherical configuration defined by a first diameter of a circle that is perpendicular to a plane tangent to the arcuate configuration taken at a distance of approximately 2.6 inches from a lowest point on the inside surface and a second diameter of a circle that is parallel to the first diameter taken at a distance of approximately 5.6 inches from the lowest point on the inside surface. The first diameter is between 11 and 17 inches, the second diameter is between 15.5 and 23 inches. The ratio of the first diameter relative to the second diameter is between 0.67 and 0.77.

In a preferred embodiment, the first diameter is between 13.5 and 15 inches and the second diameter is between 17.5 and 21 inches.

In another preferred embodiment, the first diameter is approximately 14 to 14.5 inches and the second diameter is approximately 19 to 20 inches.

In yet another preferred embodiment, the bed assembly is filled with a plural of fiber bundles that are heated so as to melt into a integrally formed article

In another aspect of the invention, the invention comprises a bed system for a pet comprising a bed assembly having an outside shell and an inside surface opposing the outside shell. The inside surface comprises an outwardly concave configuration that includes a depth. The outwardly concave configuration has a substantially ellipsoidal configuration defined by the interaction of a pair of circles, each of which are perpendicular to a plane tangent to the arcuate configuration taken at a distance of approximately 1 inch from a lowest point on the inside surface and a second pair of circles each of which are parallel to the first pair of circles taken at a distance of approximately 2 inches from the lowest point on the inside surface. The diameter of the first of the first pair of circles being approximately 17 to 22. The diameter of the second of the first pair of circles being approximately 2.75 to 4. The diameter of the first of the second pair of circles being approximately 22.75 to 30. The diameter of the second of the second pair of circles being approximately 4.75 to 6. Preferably the ratio of the diameter of the second larger circle to the first larger circle is approximately between 1.23 and 1.48. The ratio of the diameter of the large circle relative to the small circle for each of the first and second sets of circles is approximately between 4.25 and 6.75.

In one embodiment, the bed assembly is filled with a plural of fiber bundles that are heated so as to melt into a integrally formed article

### BRIEF DESCRIPTION OF THE DRAWINGS

The disclosure will now be described with reference to the drawings wherein:

FIG. 1 of the drawings is a perspective view of the bed system for a pet, showing, in particular, the curled up position comfortable to a pet;

FIG. 2 of the drawings is a perspective view of the bed system for a pet, showing, in particular, the major diameter, minor diameter and depth of the inside surface;

FIG. 3 of the drawings is a side elevational view of the bed system for a pet;

FIG. 4 of the drawings is a perspective view of the bed system for a pet, showing, in particular, one type of base;

FIG. 5 of the drawings is a side elevational view of the bed system for a pet shown in FIG. 4;

FIG. 6 of the drawings is a perspective view of the bed system for a pet, showing, in particular, another type of base;

FIG. 7 of the drawings is a perspective view of the bed system for a pet, showing, in particular, a surface configuration on the inside surface;

FIG. 8 of the drawings is a perspective view of the bed system for a pet, showing, in particular, a surface configuration on the inside surface;

FIG. 9 of the drawings is a perspective view of the bed system for a pet, showing, in particular, a surface configuration on the inside surface;

FIG. 10 of the drawings comprises a perspective view of the bed system for a pet, showing, in particular, a dimensional analysis of an embodiment of a bed intended for a cat;

FIG. 11 of the drawings comprises a perspective view of the bed system for a pet, showing, in particular, a dimensional analysis of an embodiment of a bed intended for a cat;

FIG. 12 of the drawings comprises a perspective view of the bed system for a pet, showing, in particular, a dimensional analysis of an embodiment of a bed intended for a dog;

FIG. 13 of the drawings comprises a perspective view of the bed system for a pet, showing, in particular, a dimensional analysis of an embodiment of a bed intended for a dog;

### DETAILED DESCRIPTION OF THE DISCLOSURE

While this invention is susceptible of embodiment in many different forms, there is shown in the drawings and described herein in detail a specific embodiment with the understanding that the present disclosure is to be considered as an exemplification and is not intended to be limited to the embodiment illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

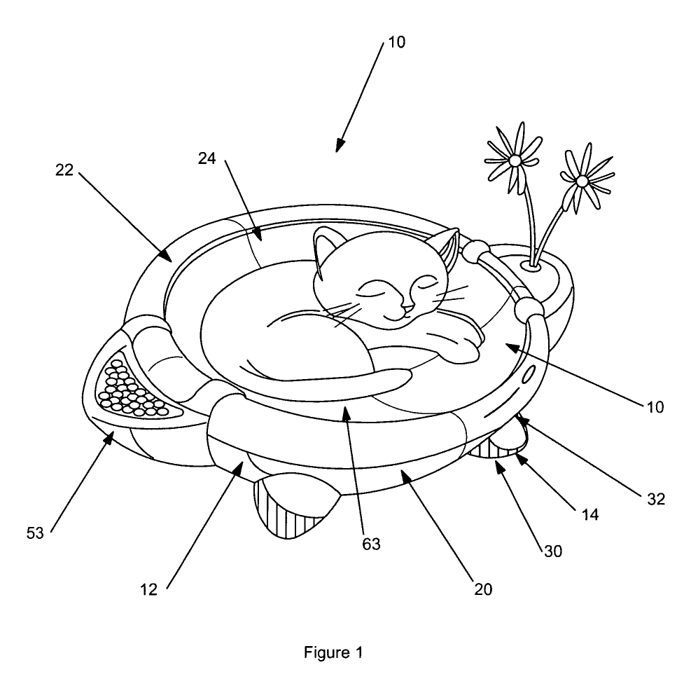

Referring now to the drawings and in particular to FIG. 1, a bed system for a pet is shown generally at 10. The bed system for the pet includes a bed assembly 12 and a base 14. The bed assembly includes an outside shell 20, outer rim 22 and inside surface 24. The outside shell comprises any number of different configurations, such as hemispherical, square or otherwise. In certain embodiments, a piece of furniture, like a chair, bed or the like can be mimicked. In other configurations, the outside shell mimics the configuration of the inside surface of the bed assembly. Generally, the outside surface may be covered with a fabric 63 or the like.

Outer rim 22 generally comprises a semi-circular configuration which stems between the outside shell and the inside surface. In one embodiment, the outer rim comprises a semi-circular configuration that is relatively uniform. The semi-circular configuration may include channels and the like. The purpose of such channels is to couple or attach various accessories 53 to the outer rim. For example, a food dish may include a handle member that is matingly configured to match the configuration of the outer rim. The handle member includes tabs or the like that interface with the channels associated with the outer rim. This interface locks the accessory to the outer rim, and in turn, the bed assembly. Among other accessories, dishes, chew toys, storage bins and the like are contemplated for use. In other embodiments, the accessories can be molded to the outer shell or to the outer rim.

Inside surface 24 is shown in FIG. 2 as extending within the outer rim and defining a cavity 26. The inside surface includes an outwardly concave configuration 12 having a major diameter 44, a minor diameter 46 and a depth 48. The inside surface is hemispherical or ellipsoid in configuration. In one embodiment, the major and minor diameters are identical and are related to the depth. In another embodiment, the major diameter is greater than the minor diameter and both are related to depth.

It is significant that the depth be such that the pet is naturally prompted into a comfortable position. For example, the depth is such that the major diameter is generally between 2.5 and 6 times the depth. The greater the ratio of depth to width, the more the pet has a tendency to roll into the middle of the bed. The less the ratio of depth to width, the less the pet is prompted into the desired comfortable position. The minor diameter is generally between 0.5 and 1 times the major diameter. For example, the depth may be approximately 5 inches, the major diameter may be 24 inches and the minor diameter may be 18 inches. Of course, other dimensions are likewise contemplated for use. In certain embodiments, the point of greatest depth may be offset such that it is not centrally located. In other embodiments, the point of greatest depth may be centrally located (i.e., at the midpoint of each of the major and minor diameters.

With reference to FIGS. 10 and 11, which pertain to a generally substantially hemispherically shaped bed, in addition to the depth, the curvature of the surface is contoured to match the pet. Generally, although not required, for a hemispherical bed, the curvature is such that at a distance, or height 202 approximately 2.6 inches from the base of the bed (i.e., the lowest point 204 on the sleep surface), the diameter of a circle 200 made perpendicular to a plane tangent to the base of the bed has a diameter of approximately 11 to 17 inches, and more preferably a diameter of approximately 13.5 to 15 inches, and most preferably approximately 14 to 14.5 inches. At a height 206 of approximately of 5.6 inches from the base of the bed, the diameter of a circle 210 made perpendicular to circle 210 has a diameter of approximately 15.5 to 23.5 inches, and more preferably a diameter of approximately 17.5 to 21 inches, and most preferably a diameter of approximately 19 to 20 inches. The diameter of the circle 210 always being larger than the diameter of circle 200 such that the ratio of diameter 200 relative to diameter 210 is approximately between 0.67 and 0.77.

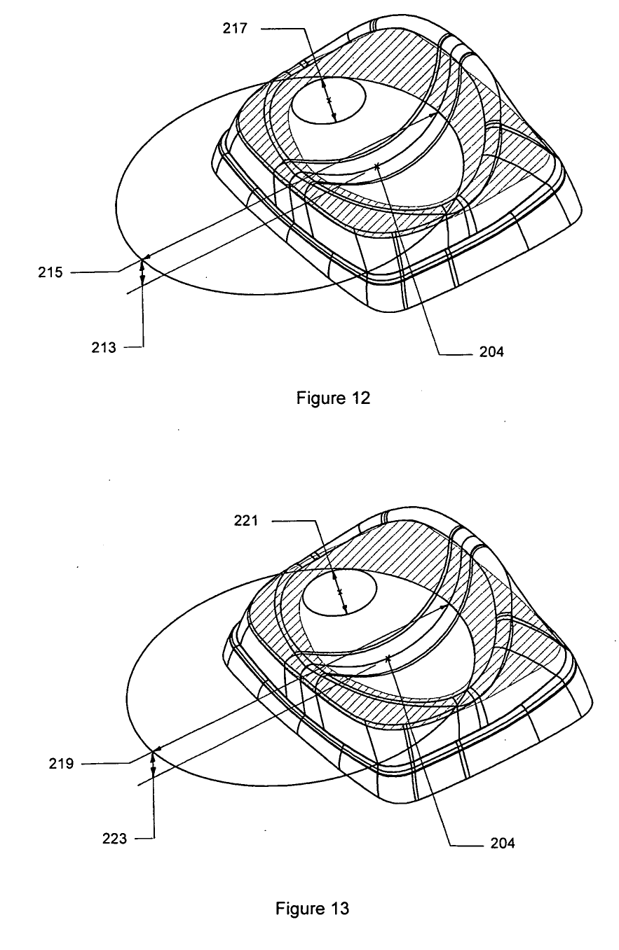

With reference to FIGS. 12 and 13, which pertain to a generally substantially ellipsoidal shaped bed, in addition to depth, the curvature of the surface is contoured to match the pet. Generally, although not required, for an ellipsoid bed, the curvature is such that at a distance/height 213 of approximately 1 inch from the base of the bed (i.e., the lowest point 204 on the sleep surface), the elliptical shape is formed by the cooperation of two smaller circles, the first of which 215 has a diameter of between 17 and 22 inches, the second 217 of which has a diameter of between 2.75 and 4 inches. At a distance 223 of 2 inches from the base of the bed, the elliptical shape is formed by the cooperation of two smaller circles, the first of which 219 has a diameter of between 22.75 and 30 inches, the second of which 221 has a diameter of between 4.75 and 6 inches. Preferably the ratio of the diameter of the second larger circle to the first larger circle is approximately between 1.23 and 1.48. The ratio of the diameter of the large circle relative to the small circle for each of the first and second sets of circles is approximately between 4.25 and 6.75. The table below sets forth some dimensions of preferred embodiments, and it will be understood that these are only preferred embodiments and not to be considered in any manner limiting.

| Distance from the | Large circle | Smaller circle |
|---|---|---|
| base of the bed | diameter | diameter |
| Small Size | | |
| 1 | 3.25 | 18 |
| 2 | 5 | 23.5 |
| Medium | | |
| 1 | 3 | 19 |
| 2 | 5.5 | 26 |
| Large | | |
| 1 | 3.75 | 21 |
| 2 | 5.5 | 29.5 |

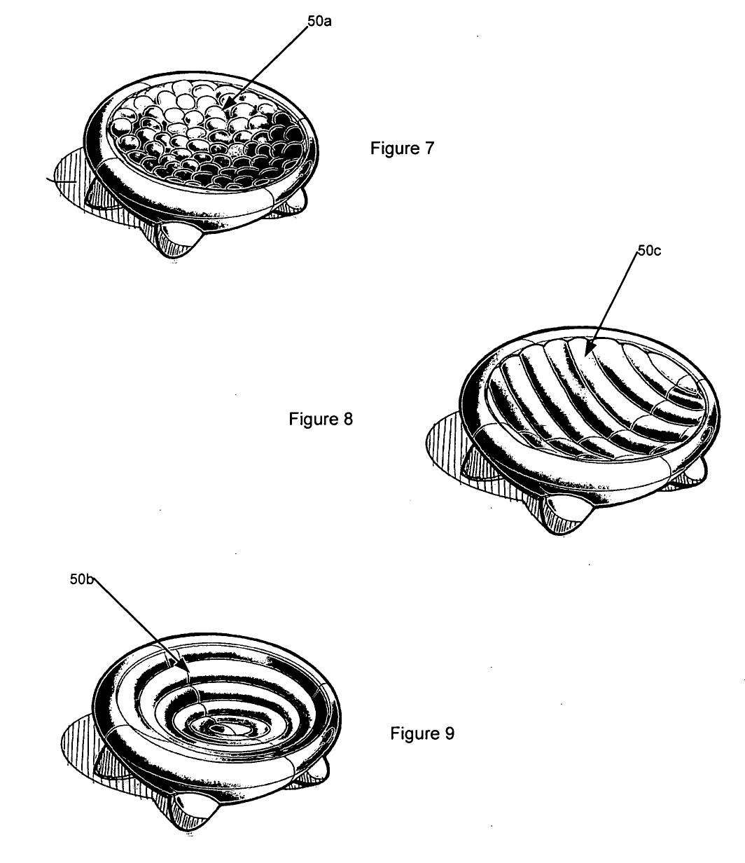

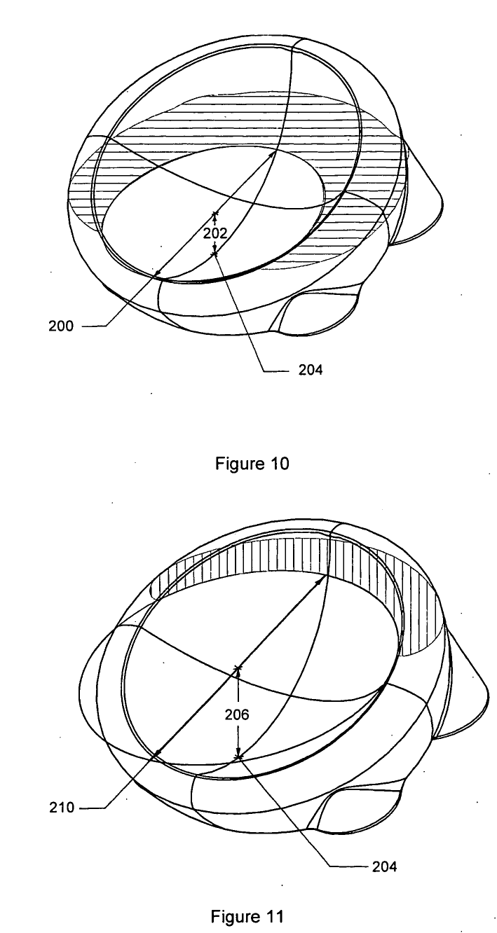

In certain embodiments, such as is shown in FIGS. 7 through 9 a surface configuration, such as surface configurations 50a through 50c can be applied to the inside surface 24. In particular, in one embodiment, the inside surface may comprise a plurality of hemispherical convex structures 50a that are space about the inside surface. In another embodiment, a plurality of nested convex rings 50c may extend circumferentially about the inside surface. In still other embodiments, a plurality of convex ribs 50b may be positioned along the inside surface.

One advantageous feature of the present invention is that it is formed from a plurality of fiber bundles that are bonded together. The fiber bundles can be blown into a mold in a particular pattern and then heated to bond the fibers to each other. Such a construction allows for the formation of the more complex shapes disclosed herein. One such method for forming the articles is shown and described in co-pending application Ser. No. 12/004,560 filed Dec. 21, 2007, entitled “System and Method of Forming an Article, and an Article Formed Thereby,” the entire specification of which is hereby incorporated by reference in its entirety. The method shown therein allows for the formation of complex shapes with the use of different fibers in different portions of the bed assembly. For example, fibers that are stronger and less flexible can be utilized near the outer rim for rigidity, whereas cushion fibers can be more extensively utilized on the inside surface to enhance the comfort of the pet. Additionally, a fabric 63 (FIG. 1) can be bonded to the fibers to form the outside shell and inside surface.

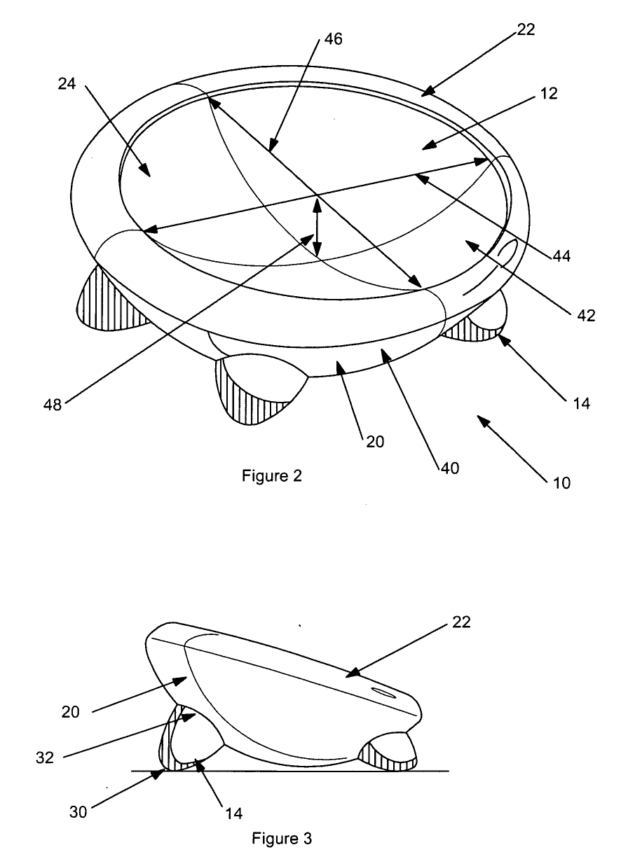

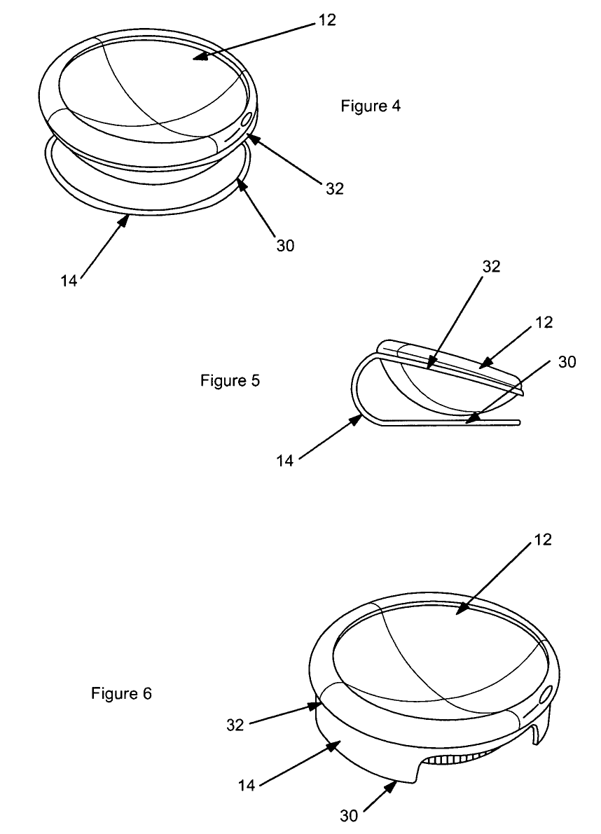

Base 14 is shown in FIG. 3, 4 as comprising surface engagement member 30 and bed assembly coupling 32. In certain embodiments, the base may comprise a tubular frame which includes a portion that rests on the surface and another portion that is coupled to the bed. In another embodiment, the base may comprise a platform which extends from the outside surface to the an area near the outer rim. In other embodiments, the base may comprise a plurality of discrete appendages which form feet-like structures that extend from the outside shell. In certain embodiments, the base may comprise a construction that is composed of fiber bundles, wherein the fiber bundles are specifically picked so as to provide a sturdy base. The base may comprise a metal member, or a polymer based member, although other materials are likewise contemplated for use.

Advantageously, when in use, the pet is able to curl up in a configuration wherein the natural curled position coincides with the natural curvature of the pet and the pets natural tendency to curl. Additionally, the fiber bundle based material can be easily washed and dried, while not retaining moisture. The material is breathable so as to enhance comfort to the pet, and to minimize microbial growth. As the bed assembly is molded from a plurality of fiber bundles and covered with a fabric, cracks and crevices can be eliminated, which, in turn, eliminates many of the areas that trap and retain dirt.

The foregoing description merely explains and illustrates the invention and the invention is not limited thereto except insofar as the appended claims are so limited, as those skilled in the art who have the disclosure before them will be able to make modifications without departing from the scope of the invention.

1. A bed system for a pet comprising:
a bed assembly having an outside shell and an inside surface opposing the outside shell, the inside surface comprising an outwardly concave configuration that includes a depth, the bed assembly being filled with a plural of fiber bundles that are heated so as to melt into a integrally formed article.

2. The bed system for a pet of claim 1 wherein the inside surface comprises a substantially hemispherically shaped configuration defined by a major diameter, a minor diameter and a depth collectively defining a cavity.

3. The bed system for a pet of claim 2 wherein the major diameter is between 2.5 and 6 times the depth, and wherein the minor diameter is between 0.5 and 1 times the major diameter.

4. The bed system for a pet of claim 3 wherein a fabric is bonded to each of the outside shell and inside surface.

5. The bed system for a pet of claim 2 wherein the major diameter and the minor diameter are substantially identical.

6. The bed system for a pet of claim 1 further comprising an outer rim transitioning from the outside shell to the inside surface.

7. The bed system for a pet of claim 6 wherein the outer rim comprises a semicircular configuration.

8. The bed system for a pet of claim 7 further comprises at least one accessory coupled to the outer rim of the bed assembly.

9. The bed system for a pet of claim 8 wherein the at least one accessory is selected from the group consisting of dishes, chew toys and storage bins.

10. The bed system for a pet of claim 1 wherein the fiber bundles comprise a plurality of different types of fiber bundles which are positioned in predetermined locations so as to provide a predetermined localized density and fiber bundle type.

11. The bed system for a pet of claim 1 further comprising a base having a surface engagement member and a bed assembly coupling, the surface engagement member structurally configured to engage an outside surface and the bed assembly coupling configured to engage the outside shell of the bed assembly to provide structure thereto.

12. The bed system of claim 1 wherein the inside surface further includes an inside surface configuration comprising a plurality of convex surface structures positioned thereon and emanating therefrom.

13. A bed system for a pet comprising:
a bed assembly having an outside shell and an inside surface opposing the outside shell, the inside surface comprising an outwardly concave configuration that includes a depth, the outwardly concave configuration having a substantially hemispherical configuration defined by a first diameter of a circle that is perpendicular to a plane tangent to the arcuate configuration taken at a distance of approximately 2.6 inches from a lowest point on the inside surface and a second diameter of a circle that is parallel to the first diameter taken at a distance of approximately 5.6 inches from the lowest point on the inside surface, the first diameter being between 11 and 17 inches, the second diameter being between 15.5 and 23 inches, and a ratio of the first diameter relative to the second diameter being between 0.67 and 0.77.

14. The bed system for a pet of claim 13 wherein the first diameter is between 13.5 and 15 inches and the second diameter is between 17.5 and 21 inches.

15. The bed system for a pet of claim 13 wherein the first diameter is approximately 14 to 14.5 inches and the second diameter is approximately 19 to 20 inches.

16. The bed system for a pet of claim 13 wherein the bed assembly is filled with a plural of fiber bundles that are heated so as to melt into a integrally formed article

17. A bed system for a pet comprising:
a bed assembly having an outside shell and an inside surface opposing the outside shell, the inside surface comprising an outwardly concave configuration that includes a depth, the outwardly concave configuration having a substantially ellipsoidal configuration defined by the interaction of a pair of circles, each of which are perpendicular to a plane tangent to the arcuate configuration taken at a distance of approximately 1 inch from a lowest point on the inside surface and a second pair of circles each of which are parallel to the first pair of circles taken at a distance of approximately 2 inches from the lowest point on the inside surface, the diameter of the first of the first pair of circles being approximately 17 to 22, the diameter of the second of the first pair of circles being approximately 2.75 to 4, the diameter of the first of the second pair of circles being approximately 22.75 to 30, and the diameter of the second of the second pair of circles being approximately 1.23 to 1.48.

18. The bed system for a pet of claim 17 wherein the bed assembly is filled with a plural of fiber bundles that are heated so as to melt into a integrally formed article

19. The bed system for a pet of claim 17 wherein a ratio of the diameter of the first of the first pair of circles relative to the first of the second pair of circles is approximately between 1.23 and 1.48.

20. The bed system for a pet of claim 17 wherein the ratio of the first of the first pair of circles to the second of the first pair of circles is between 4.25 and 6.75.
